(19) United States
(12) Patent Application Publication
(10) Pub. No.: US 2022/0245995 A1
(43) Pub. Date: Aug. 4, 2022

(54) REALISTIC SCORING FANTASY FOOTBALL

(71) Applicant: Todd A. Birk, Alpine, WY (US)

(72) Inventor: Todd A. Birk, Alpine, WY (US)

(21) Appl. No.: 17/033,377

(22) Filed: Sep. 25, 2020

(51) Int. Cl. G07F 17/32

(52) U.S. Cl. CPC G07F 17/3237

(57) ABSTRACT

In accordance with one or more embodiments of the invention, realistic scoring systems and methods for fantasy football are presented, along with related league systems and methods. Positive and negative per-event and per-yard portions are evaluated.

### BACKGROUND OF THE INVENTION

### Field of Invention

The invention disclosed herein generally relates fantasy football. More specifically, the invention disclosed herein relates to realistic scoring of fantasy football, and related league systems and methods.

### Description of Related Art

Different types of fantasy sports, including fantasy football, leagues and scoring systems have been used. In many prior art fantasy football leagues, a touchdown is valued at 6 points, an extra point at 1 point and a field goal at 3 points. If you combine this with their yardage points you end up with scores similar to a Harlem Globetrotter basketball score (example 175-155).

### BRIEF SUMMARY OF EMBODIMENTS OF THE INVENTION

Some aspects of the invention include a scoring system normalized to typical scores of professional football games. Professional football scores may be quantitatively analyzed over varying periods of time, and statistics may be generated based on those scores. For example, average or median scores of professional football games may be calculated, and the scoring systems disclosed herein may be normalized to one or more statistical evaluations of those scores. Scoring systems and normalizations may be performed at different intervals, for example once per season, once per week during the season, once during the regular season and once during playoffs, and other combinations or different amounts of time between the frequency of adjustment. By way of example, in recent years, the top twelve professional football teams have averaged approximately twenty-eight points per game; thus some embodiments include normalization of fantasy football scores to a 28-point standard. The scoring may be evaluated based on the top, e.g., twelve players at each position. Scoring may also be evaluated based on the top eight players at each position, or based on another number of top players at each position, and could be evaluated based on different numbers of players in different positions.

Aspects may also include competitive schedules with schedule positioning rounds, for example positioning rounds around week 7 and week 14 of the season, or around other weeks. In a preferred embodiment, any particular team may play every other team every week in the overall professional schedule. In some aspects, weeks 15 though 17 of the season may be tournament weeks with multiple games.

Other than injured players or byes, there are preferably no active players on the bench for any game. Injury protection may be available for players who's status is questionable or worse, and a backup player may be selected at that position for a game-time decision. Waivers may be available each week with lowest place priority.

In the fantasy playoffs, any players playing in the professional football playoffs may be selected each week, but there is preferably a limit of two players for any single professional team available to be selected to a fantasy team.

The following are some of what may be evaluated for head to head records for divisions: overall record; total points scored; tournament placing; regular season coach rating; most valuable players at each position; playoff touchdowns, playoff scoring champion, and coach of the year.

In accordance with one or more embodiments of the invention, realistic fantasy football scoring and related league inventions are presented.

Certain of the aspects include: a realistic scoring system for fantasy football that rewards individual performances by statistical distance at multiple positions with a quantified score proportional to team participation, the system comprising a positive per-event portion of a fantasy football scoring algorithm that assigns positive points based on a multiplier for each of touchdown pass completed, touchdown rush completed, touchdown reception completed, turnovers for the team on defense from an interception, turnovers for the team on defense from a fumble recovery, 2-point conversions from passing, 2-point conversions from rushing, 2-point conversion receptions, successful extra points attempts, successful field goal attempts, interceptions by the defensive team, fumbles attributed to the team on defense, defensive sacks of a quarterback, safeties attributed to the team on defense, kickoff touchbacks, turnovers based on a fumble attributed to special teams, special teams touchdowns, special teams 1-point safety, and punts blocked by the defense; a negative per-event portion of a fantasy football scoring algorithm that assigns negative points based on a multiplier for each of turnovers from an interception charged against a team or player on offense, turnovers from a fumble recovery charged against a team or player on offense, unsuccessful kicking extra points attempts, and missed field goal attempts; a positive per-yard portion of a fantasy football scoring algorithm that assigns additional positive points based on a per-yard-multiplier for each of pass completed, rush completed, reception completed, touchdown pass completed, touchdown rush completed, touchdown reception completed, successful field goal attempts, touchdown yards by team on defense, touchdown yards by special teams, punt returns, kick off returns, and special teams touchdowns; and a negative per-yard portion of a fantasy football scoring algorithm that assigns negative points based on a per-yard-multiplier for yards against the team on defense, where yards against the team on defense includes completed offensive passing yards and completed offensive rushing yards, where different positions account for different proportions of a team's performance.

Some aspects may include one or more of the following: scoring weightings are adjusted based on a statistical evaluation; data analysis from real professional football games using the positive and negative per-event and per-yard portions of the fantasy football scoring algorithm, analyzing the top performers as quarterbacks, running backs, wide receivers, tight ends, kickers, defense, and special teams, where the analysis informs adjusted values of per-event and per-yard scoring such that fantasy football team scores are normalized to real professional football team scores; where the scores are normalized to approximately 28 points per game per team; wherein each team is comprised of nine players; wherein the nine positions include one quarterback, two running backs, two wide receivers, one tight end, one kicker, one defensive player, and one special team player; wherein the scoring system is normalized to an average score based on a series of professional football games; wherein the average score based on a series of professional football games is a 28-point game for each team; wherein the defense is given a fixed point amount for each game, to be subtracted by values per point scored against and per yard achieved against, and to be added by values per turnovers and negative yardage; wherein the proportion of team score attributable to each position is approximately 15% for quarterbacks, 10% for each of the two running backs, 10% for each of the two wide receivers, 7% for tight ends, 10% for kickers, 25% for defense, and 3% for special teams.

### BRIEF DESCRIPTION OF THE DRAWINGS

For a more complete understanding of various embodiments of the present invention, reference is now made to the following descriptions taken in connection with the accompanying drawings in which:

FIG. 1 illustrates an exemplary scoring breakdown.

FIG. 2 illustrates an exemplary fantasy football team.

FIG. 3 illustrates an exemplary scoring summary.

### DETAILED DESCRIPTION OF EMBODIMENTS OF THE INVENTION

The inventions disclosed herein allow for realistic scoring of fantasy football, and related league systems and methods.

The fantasy football league of the present invention provides a competitive and realistic coaching and scoring experience. The number of teams in a fantasy league of the present invention may vary, but a preferred embodiment comprises a 12 team league and another preferred embodiment comprises an 8 team league. The scoring system may reward individual performances by the yard at each position, with a quantified score proportional to team participation. The points integrate into a team score that is realistic to an actual football score. The competition may start at a draft and may end at the Super Bowl with a selected Coach of the Year as the overall champion. The regular season schedule is dynamic, such that week 1 may be as exciting as week 17. Division and conference rivalries may be scheduled along with two positioning rounds during the first 14 weeks. Weeks 15 through 17 may consist of an end of the season tournament that establishes a new dimension to evaluate coaching ability. The playoffs have a unique twist that challenges coaching ability and strategy all the way to the Super Bowl. The Fantasy Coach of the Year represents an analytical determination based on performances in many categories throughout the season. The league may start out with a commissioner who would send out invites to the other coaches or each individual may sign up and be assigned a league. A basic breakdown of the league, and the scoring system, is summarized in the following paragraphs.

Draft: The draft order typically establishes the team number for each team owner, which then determines the divisions and conferences for the teams along with their schedule. The order is preferably selected randomly for the draft and proceeds from selection of random numbers 1 through 12 assigned to each team. The 12^{th} pick may make two selections and the order then descends back down to the first pick. This order may continue through nine rounds of selections. Each owner selects, e.g., 9 positions during the draft, which preferably consists of 1 Quarterback, 2 Running Backs, 2 Wide Receivers, 1 Tight End, 1 Kicker, 1 Defense and 1 Special Team to establish their fantasy football team. Each bench is preferably only used for potentially injured players and byes for that position.

Conferences and Divisions: In a 12-team league, Teams 1 through 3 may be designated as the North Division. Teams 4 through 6 may be designated as the South Division. The North and South Divisions may make up the National Conference. Teams 7 through 9 may be designated as the East Division. Teams 10 through 12 may be designated as the West Division. The East and West Divisions may make up the American Conference. These are illustrated in the figures, and this is known as the head to head record which reflects the teams record as they play in the regular season and tournament.

Schedule: The regular season schedule may have three different components during a 17-week season. These components would consist of the regular schedule, positioning rounds, and the end of the season tournament. During the regular season schedule, Weeks 1 through 6 and weeks 8 through 13 may have each team playing the other teams in their division once in each section for a total of two times. Each team may also play the other teams in their conference one time during these 12 weeks. The remaining games may include match ups with teams from the other conference with the exception of one team. Weeks 7 and 14 may be positioning rounds, e.g., having the 1^{st} place team playing the 2^{nd} place team, 3^{rd} playing 4^{th}, 5^{th}, playing 6^{th}, 7^{th} playing 8^{th}, 9^{th} playing 10^{th} and 11^{th} playing 12^{th}. This method tightens up the competition prior to the regular season tournament. The regular season schedule matrix is illustrated in the figures.

Regular Season Tournament: The end of the regular season tournament is preferably played during weeks 15, 16 and 17. It may consist of each division team playing the other teams within their division in week 15 or playing two games that week. The National conference may be bracketed together as well as the American conference. The winners of both games in week 15 may move forward in the winners' bracket of their division and proceed to the conference championship (tournament semifinals) against their other division winner. The losers may move to the consolation round and play the other three teams in their conference. The winners of the conference championship (tournament semifinals) may play each other in the tournament championship finals (tournament 1^{st} and 2^{nd} place). The losers of the conference championships may move to the consolation finals along with the top two winners from the consolation round of each conference. These six teams may play each other (five games) in the consolation finals (3^{rd} through 8^{th} place). The two losers from each conference of the consolation round may move to the Toilet Bowl of the tournament. These four teams may play each other (three games) for the Toilet Bowl results (9^{th} through 12^{th} place). This preferably results in any individual team playing as little as 18 games or as many as 24 games in the regular season. The division champions may be based on their winning percentage at the end of the regular 17 week season. So the team that wins the tournament may have a 4 wins 0 loss record for the final three weeks. However, the 3^{rd} place team may have anywhere between 9 wins and 1 loss, 7 wins and 1 loss, 8 wins and 2 losses or 7 wins and 3 losses depending on when they moved into the consolation rounds and how they performed. This gives several teams an opportunity to improve their regular season winning percentage and possibly win their division from behind.

Scoring: The scoring system disclosed herein is predicated on individual performances and how they relate to the total team participation. The scoring system of the present invention yields results in a more realistic football score (example 28.24-27.78) based on, e.g., 28 points per game, which is approximately what the top 12 professional teams score. A quarterback may score as little as 1 point for a poor performance or as many as 7 points for an outstanding performance, and may average about 4.2 points per game which is approximately 15% of the team score. Likewise, a running back or wide receiver may score as little as 0.5 points for a poor performance and as many as 7 points for an outstanding performance averaging about 2.8 points per game which is approximately 10% of the team score. A tight end may score as little as 0.1 points for a poor performance or as many as 5 points for an outstanding performance, averaging about 1.9 points per game which is approximately 7% of the team score. A kicker may score as little as 0 or possibly negative points (missed field goals) or as many as 7 points, averaging about 2.8 points per game which is approximately 10% of the team score. A defense may score as little as 3 points for a poor performance and as many as 14 points for an outstanding performance, averaging about 7 points per game which is approximately 25% of the team score. A special team may score as little as 0 points for a poor or inactive performance or as many as 5 points averaging 1 point per game. A typical team score may range anywhere between 12 or 14 points for a poor performance to over 40 points for an outstanding performance. Many of the team scores are between 26 and 32 points since each team typically has some outstanding performers as well as some poor performers.

Quarterbacks (“QBs”), running backs (“RBs”), wide receivers (“WRs”) and tight ends (“TEs”) points are preferably accumulated for each yard gained, each touchdown scored as well as a bonus points for each yard of the touchdown scored, in increments of thousandths (0.001) and hundredths (0.01) of a point, respectively. Likewise, negative points may be deducted for each interception thrown or fumble loss. Kickers points may be accumulated for extra points and field goals and negative points deducted for misses. Defenses may start out with 12 points and have points deducted for each yard gained and each point scored against them. Points may be accumulated for defensive touchdowns scored as well as bonus points for each yard of the touchdown scored in increments of thousandths (0.001) and hundredths (0.01) of a point, respectively. Points may also be accumulated for fumbles recovered and interceptions received, as well as safeties scored. Special team points may be accumulated for each yard gained and each touchdown scored, as well as a bonus points for each yard of the touchdown scored in increments of thousandths (0.001) and hundredths (0.01) of a point, respectively for punt and kickoff returns. Touchbacks may be rewarded as twenty accumulated yards gained. Likewise, negative points may be deducted for each fumble loss or punts blocked.

Bench or Reserve Players: One of the main reasons that leagues using the disclosed scoring system are so competitive is the player pool of potential players. The bench can preferably only be used for a player that has a questionable or doubtful injury, on injured reserve, in-active, suspended, or has a bye. If a player has a bye that week than the bye player may be placed on the bench and an active free agent player of the same position may be selected in the lineup in the place of the benched player. If a player has an injury or suspension then the owner may have first rights to the player's backup in a depth chart at the same position. Typically, an owner can only select one player for a replacement, so if this player is injured as well, it would then be at the owners risk. Team lineups of the professional football teams may be scanned periodically prior to and potentially just before a game to check or confirm the status of a player and to potentially automatically pick up the next player on the depth chart or possibly drop the bench player if the active player is deemed uninjured or has a probable status.

Waivers Preferably at the beginning of each week after the Monday night game, and before any team can pick up any players, a waiver process is performed. During this process each owner may submit their choices for adds and or drops for that week including their injury replacements. A team must typically have established a legal lineup to make these selections dropping any extra players or the replacement player from their team used the previous week for a bye or injury. The waivers may be performed at a designated time and date (e.g. on Wednesdays at 8 PM EST) for that week's selection. The team with the lowest coaches score may have the first priority to any player all the way through the team with the highest coaches score with the last priority. After the waiver process, then drop adds are based on a first come first serve basis except for injuries.

Overall Record The overall record is preferably based on a simulation of playing each and every team each week as illustrated in the drawings, except the “played” may be replaced with Head to Head and the “ALL” may be replaced with Overall.

Regular Season Competition: The regular season competition is preferably based on each team's rankings in four categories of achievement over the 17 weeks of the season, all combined into a coaching score. The regular season Head to Head game record based on the schedule may determine the champion of each division. Total scoring represents a teams points accumulated from each week's scores, and may be quantified on the conference and division page. The overall record was discussed above. Finally, each team's tournament placement may be determined. These rankings are preferably given point values of 12 for first place all the way down to 1 point for twelfth place, in the example of a 12-team league. This accumulated point value then determines a team's coaching score. This is illustrated in the figures.

Each position preferably has a most valuable player selected based on the players fantasy points accumulated throughout the season. The league most valuable player may be selected by the 12 coaches based on their interpretation of the player's fantasy football performance.

Regular Season Prize Distribution: An exemplary prize point distribution for each team is illustrated in the figures.

Post Season Competition: The post season competition preferably has each team's roster cleared and each coach may select any player from any of the professional football teams playing in the playoffs that week. Any player may be on multiple fantasy teams. A single player may even be on all fantasy teams. The only stipulation is preferably that a fantasy team should not have more than two players from any one professional team, with the exception of the special team which can be from any team playing that week. No two teams can typically be exactly the same on a first come first serve basis and the owners may change their team right up to even a few minutes before game time. Each week in the post season the rosters should be cleared and new players may be selected, based on only the teams playing that week for the Wildcard Games, Division Games and the Conference Championship Games. As the teams accumulate points in real time, their position may change on a related graphic. An example is illustrated in the figures.

For a Super bowl game, each team may preferably be comprised of any amount of players from either team.

Coach of the Year Competition: The coach of the year is preferably an analytical breakdown based on each team's performance when compared to each other team and is illustrated in the figures.

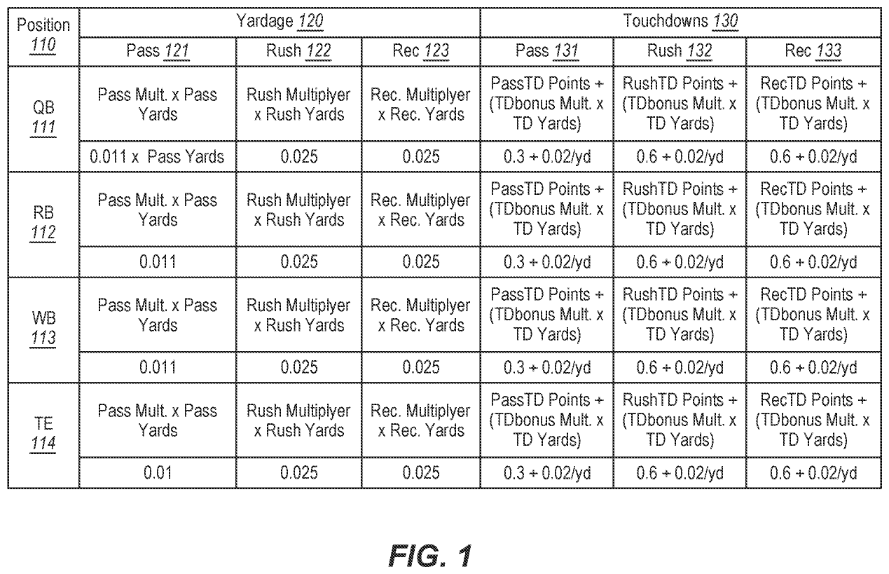

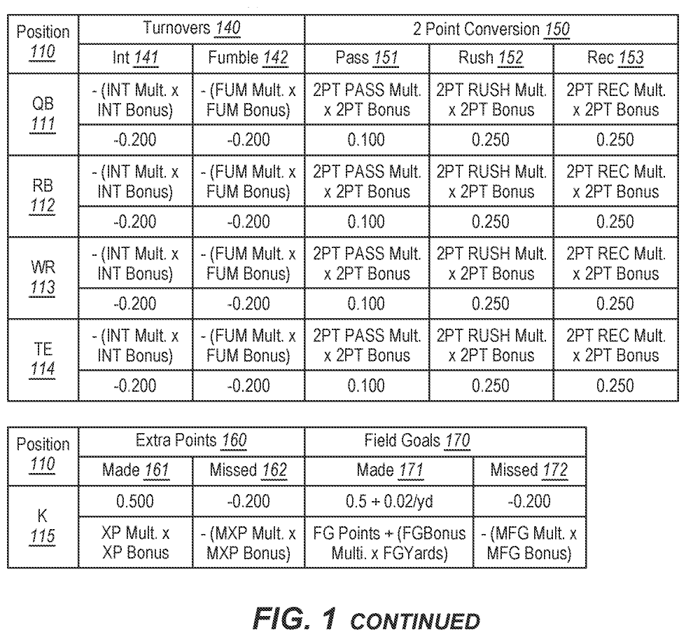

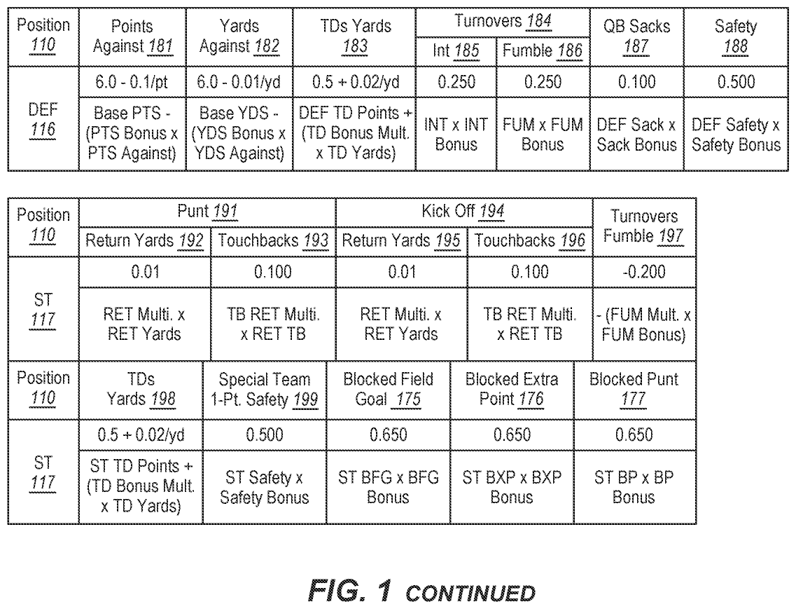

FIG. 1 illustrates an exemplary scoring breakdown. Positions 110 are illustrated in the first column of FIG. 1, and contains the following seven positions for an exemplary fantasy football team: QB 111, for quarterback; RB 112, for running back; WR 113, for wide receiver; TE 114, for tight end; K 115, for kicker; DEF 116, for defense; and ST 117, for special teams.

Yardage 120, including pass yardage 121, rush yardage 122, and receiving yardage 123 are shown, along with the respective per-yard multiple for each. As illustrated in FIG. 1, for each successful pass yard 121, 0.011 points are allocated; for each successful rush yard 122, 0.025 points are allocated, and for each successful receiving yard 123, 0.025 points are allocated. Yardage 120 (along with touchdowns 130, turnovers 140, and 2 point conversions 150) are applicable to the following positions 110: QB, RBs, WRs, and TE. Touchdowns 130 are illustrated, including passing touchdown 131, rushing touchdown 132, and receiving touchdown 133, along with the respective per-event multiple and per-yard additor for each. As illustrated in FIG. 1, for each successful touchdown pass 131, the per-event points allocated are 0.3 per touchdown pass 131 and the per-yard points allocated are 0.02 points per yard of touchdown pass 131; for each successful touchdown rush 132, the per-event points allocated are 0.6 per touchdown rush 132 and the per-yard points allocated are 0.02 points per yard of touchdown rush 132; and for each successful touchdown reception 133, the per-event points allocated are 0.6 per touchdown reception 133 and the per-yard points allocated are 0.02 per yard of touchdown reception 133.

Turnovers 140, including interceptions 141 and fumbles 142 are illustrated, along with the negative per-event points associated with each. As illustrated in FIG. 1, for each interception 141 and for each fumble 142, negative 0.2 points are allocated. 2 point conversion 150, including 2 point conversion pass 151, 2 point conversion rush 152, and 2 point conversion reception 153 are illustrated, along with the respective positive per-event points associated with each. As illustrated in FIG. 1, each successful 2 point conversion pass 151 is worth 0.1 point, each successful 2 point conversion rush 152 is worth 0.25 points, and each successful 2 point conversion reception is worth 0.25 points.

Extra points 160, including made extra points 161 and missed extra points 162 are illustrated, along with their respective positive and negative per-event value. As illustrated in FIG. 1, each made extra points 161 is worth 0.5 points, and each missed extra points 162 is worth negative 0.2 points. Field goals 170, including field goals made 171 and field goals missed 172 are illustrated. Field goals made 171 are shown with their respective positive per-event and per-yard values, as illustrated in FIG. 1, 0.5 points per field goal made 171 plus 0.02 points per yard of each field goal made 171. Field goals missed 172 are illustrated with their negative per-even points, negative 0.2 points for each field goal missed 172 as illustrated in FIG. 1. Extra points 160 and field goals 170 are allocated to position 111 of K, or kickers.

Points against 181, yards against 182, touchdown yards 183, turnovers 184 including interceptions 185 and fumbles 186, quarterback sacks 187, and safety 188 are all illustrated, along with their respective points allocated to position 111 of DEF, or defense. As illustrated in FIG. 1, points against 181 includes positive per-game points of 6 and negative 0.1 per point scored by the opposing team; yards against 182 includes positive points per game of 6 and negative 0.01 per yard of offense by the opposing team; touchdown yards 183 includes a per-event addition of 0.5 points per touchdown by the defense plus 0.02 points per touchdown yard 183; interceptions 185 by the defense are awarded 0.25 points; fumbles by the opposing team are awarded a per-event 0.25 points; quarterback sacks 187 by the defense are awarded 0.1 point per event, and safety's 188 are awarded 0.5 points per event to the defense.

Punts 191 including punt return yards 192 and punt touchbacks 193, kick off 194, including kick off return yards 195 and kick off touchbacks 196, turnover fumbles 197, touchdown yards 198, and special team 1 point safety 199, blocked field goals 175, blocked extra points 176, and blocked punts 177, all of which are attributable to position 111 of ST, or special teams, are shown with their respective point values. As illustrated in FIG. 1, punt return yards 192 are valued at a per-yard score of 0.01 per yard; punt touchbacks 193 are valued at a per-event score of 0.1 per punt touchback 193; kick off return yards 195 are given per-yard points of 0.01 points per kick off return yard 195; kick off touchbacks 196 are given per-event points of 0.1 points per kick off touchback 196; fumble turnovers 197 are given negative per-event points of negative 0.2 points per turnover fumble 197; touchdown yards 198 are given per-event points of 0.5 points each plus per-yard points of 0.02 points per touchdown yard 198; and special team 1 point safety 199 is given per-event points of 0.15 points per special team 1 point safety 199. Each blocked field goal 175, each blocked extra point 176, and each blocked punt 177 is worth 0.65 points, attributable to position 111 of ST 117, or special teams.

Specific per-event and per-yard points applicable to each position, and illustrated in FIG. 1, are exemplary, and may be altered in some aspects of the invention. In addition, other types of scoring functions in addition to or instead of multipliers may be used. For example, more complicated functions may be used for scoring one or more positions of a fantasy football game.

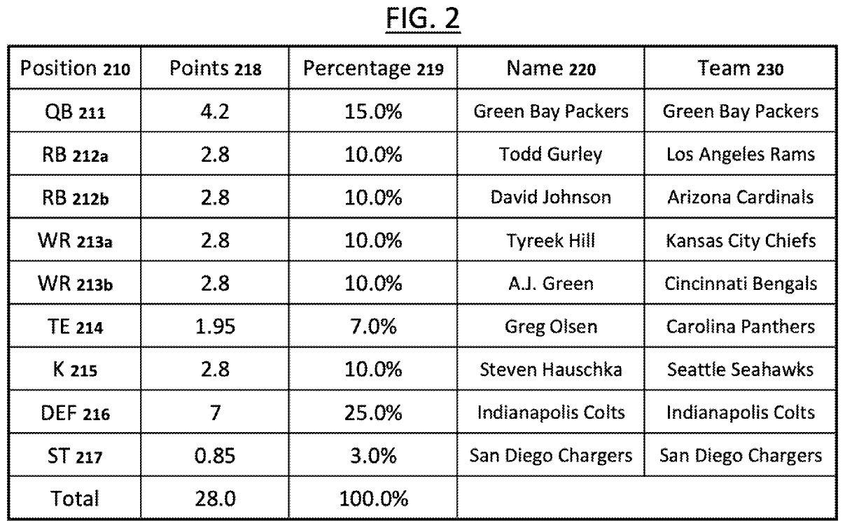

FIG. 2 illustrates an exemplary list of players and teams for each position of a fantasy football game. Position 210, Name 220, and Team 230, are illustrated in FIG. 2. Name 220 is illustrated as either a team name, here in the case of QB 211, DEF 216, and ST 217, or as one or more individual names for the other positions 210, illustrated here as first running back RB 212a, second running back RB 212b, first wide receiver WR 213a, second wide receiver WR 213b, tight end TE 214, and kicker K 215. Points 218 illustrates an exemplary allocation of points per position. Here, points 218 ranges from 1.95 for TE 214 to 4.2 for QB 211. Points 218 in this example adds to a total of 28 points. Percentage 219 illustrates the percentage of total points allocated to each of Points 218. Team 230 represents the team on which each name 220 of position 210 plays. Exemplified in FIG. 2 is a professional football game. The exemplary fantasy football team illustrated in FIG. 2, is made up of: the quarterback or quarterbacks from the Green Bay Packers; running back Todd Gurley from the Los Angeles Rams; running back David Johnson from the Arizona Cardinals; wide receiver Antonio Brown from the Pittsburgh Steelers; wide receiver A. J. Green from the Cincinnati Bengals; tight end Greg Olsen from the Carolina Panthers; kicker Steven Huascar from the Seattle Seahawks; the defense of the Indianapolis Colts, and the special teams from the San Diego Chargers.

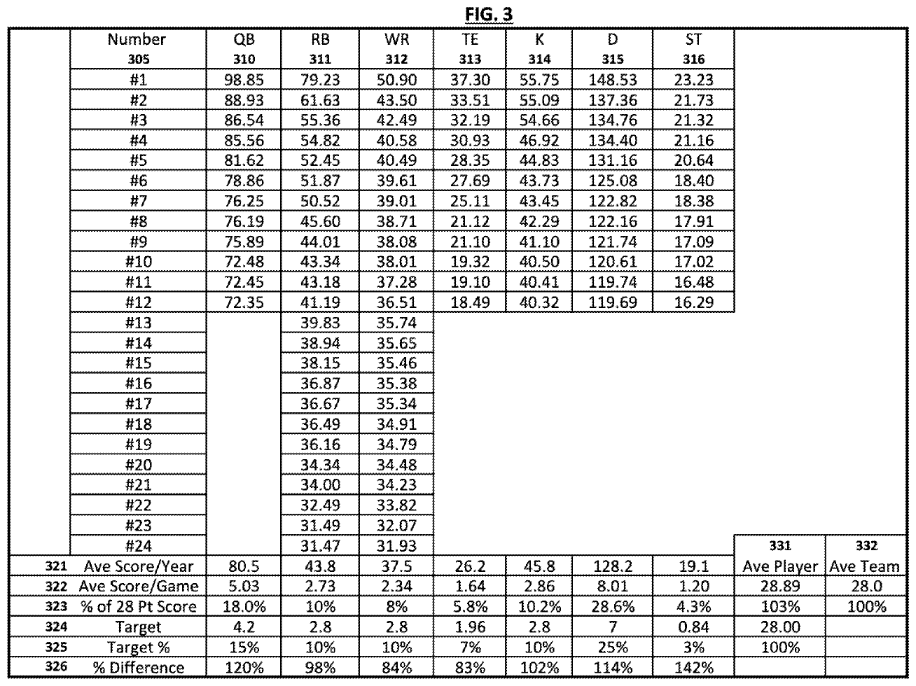

FIG. 3 illustrates an exemplary scoring summary, according to aspects of the invention. At the top of FIG. 3 is illustrated positions: quarterback 310, QB; running backs 311, RB; wide receiver 312, WR; tight end 313, TE; kicker 314, K; defense 315, D; and special teams 316, ST. Number 305 lists the top 12 players by position for QB 310, TE 313, K 314, D 315, and ST 316, and the top 24 players by position for RB 311 and WR 312, all based on scoring systems disclosed herein for the previous season. While the numbers illustrated in FIG. 3 are based on the previous complete season, they may be updated intermittently, for example each week after all games are played, or after each game is played, or on other intervals.

Average score per year 321 illustrates the average score per year per position, based on an average of the top 12 (for QB 310, TE 313, K 314, D 315, and ST 316) or 24 (for RB 311 and WR 312) players/teams by position. Average score per game 322 illustrates the average of average score per year 312 divided by 16 games based on a regular season number of games per team. Percent of 28.0 Point Score 323 illustrates the proportion of a theoretical 28.0 point score that each of average score per game 322 represents.

Target 324 illustrates the ideal weight of each position, based on a team score of 28.00. Target Percentage 325 illustrates the percentage of total points, in the ideal weighting of Target 324, for each position, totaling one hundred percent. Percent Difference 326 illustrates the relationship between Percent of 28.0 Point Score 323 and Target Percentage 325. Average by Player 331 illustrates average score per game 322, summed across all of the positions, and also the sum of Percent of 28.0 Point Score 323 summed across all of the positions. Average per team 332 is the target average score per game, of 28.0 points.

Turnovers may include fumbles, interceptions, or quarterback sacks.

As will be realized, the systems and methods disclosed herein are capable of other and different embodiments and its several details may be capable of modifications in various respects, all without departing from the invention as set out in the appended claims. Accordingly, the drawings and description are to be regarded as illustrative in nature and not in a restrictive or limiting sense with the scope of the application being indicated in the claims.

What is claimed is:

1. A realistic scoring system for fantasy football that rewards individual performances by statistical distance at multiple positions with a quantified score proportional to team participation, the system comprising:
a positive per-event portion of a fantasy football scoring algorithm that assigns positive points based on a multiplier for each of touchdown pass completed, touchdown rush completed, touchdown reception completed, turnovers for the team on defense from an interception, turnovers for the team on defense from a fumble recovery, 2-point conversions from passing, 2-point conversions from rushing, 2-point conversion receptions, successful extra points attempts, successful field goal attempts, interceptions by the defensive team, fumbles attributed to the team on defense, defensive sacks of a quarterback, safeties attributed to the team on defense, kickoff touchbacks, turnovers based on a fumble attributed to special teams, special teams touchdowns, special teams 1-point safety, and punts blocked by the defense;
a negative per-event portion of a fantasy football scoring algorithm that assigns negative points based on a multiplier for each of turnovers from an interception charged against a team or player on offense, turnovers from a fumble recovery charged against a team or player on offense, unsuccessful kicking extra points attempts, and missed field goal attempts;
a positive per-yard portion of a fantasy football scoring algorithm that assigns additional positive points based on a per-yard-multiplier for each of pass completed, rush completed, reception completed, touchdown pass completed, touchdown rush completed, touchdown reception completed, successful field goal attempts, touchdown yards by team on defense, touchdown yards by special teams, punt returns, kick off returns, and special teams touchdowns; and
a negative per-yard portion of a fantasy football scoring algorithm that assigns negative points based on a per-yard-multiplier for yards against the team on defense, where yards against the team on defense includes completed offensive passing yards and completed offensive rushing yards,
where different positions account for different proportions of a team's performance.

2. The realistic scoring system for fantasy football of claim 1, where scoring weightings are adjusted based on a statistical evaluation.

3. The realistic scoring system for fantasy football of claim 1, further comprising data analysis from real professional football games using the positive and negative per-event and per-yard portions of the fantasy football scoring algorithm, analyzing the top performers as quarterbacks, running backs, wide receivers, tight ends, kickers, defense, and special teams, where the analysis informs adjusted values of per-event and per-yard scoring such that fantasy football team scores are normalized to real professional football team scores.

4. The realistic scoring system for fantasy football of claim 1, where the scores are normalized to approximately 28 points per game per team.

5. The realistic scoring system for fantasy football of claim 1, wherein each team is comprised of nine players.

6. The realistic scoring system for fantasy football of claim 5, wherein the nine positions include one quarterback, two running backs, two wide receivers, one tight end, one kicker, one defensive player, and one special team player.

7. The realistic scoring system for fantasy football of claim 2, wherein the scoring system is normalized to an average score based on a series of professional football games.

8. The realistic scoring system for fantasy football of claim 7, wherein the average score based on a series of professional football games is a 28-point game for each team.

9. The realistic scoring system for fantasy football of claim 1, wherein the defense is given a fixed point amount for each game, to be subtracted by values per point scored against and per yard achieved against, and to be added by values per turnovers and negative yardage.

10. The realistic scoring system for fantasy football of claim 1, wherein the proportion of team score attributable to each position is approximately 15% for quarterbacks, 10% for each of the two running backs, 10% for each of the two wide receivers, 7% for tight ends, 10% for kickers, 25% for defense, and 3% for special teams.

11. A method of realistic scoring for fantasy football that rewards individual performances by statistical distance at multiple positions with a quantified score proportional to team participation, the method comprising:
receiving data representative of a positive per-event portion of a fantasy football scoring algorithm, that assigns positive points based on a multiplier for each of touchdown pass completed, touchdown rush completed, touchdown reception completed, turnovers for the team on defense from an interception, turnovers for the team on defense from a fumble recovery, 2-point conversions from passing, 2-point conversions from rushing, 2-point conversion receptions, successful extra points attempts, successful field goal attempts, interceptions by the defensive team, fumbles attributed to the team on defense, defensive sacks of a quarterback, safeties attributed to the team on defense, kickoff touchbacks, turnovers based on a fumble attributed to special teams, special teams touchdowns, special teams 1-point safety, and punts blocked by the defense;
receiving data representative of a negative per-event portion of a fantasy football scoring algorithm, that assigns negative points based on a multiplier for each of turnovers from an interception charged against a team or player on offense, turnovers from a fumble recovery charged against a team or player on offense, unsuccessful kicking extra points attempts, and missed field goal attempts;
receiving data representative of a positive per-yard portion of a fantasy football scoring algorithm, that assigns additional positive points based on a per-yard-multiplier for each of pass completed, rush completed, reception completed, touchdown pass completed, touchdown rush completed, touchdown reception completed, successful field goal attempts, touchdown yards by team on defense, touchdown yards by special teams, punt returns, kick off returns, and special teams touchdowns; and
receiving data representative of a negative per-yard portion of a fantasy football scoring algorithm, that assigns negative points based on a per-yard-multiplier for yards against the team on defense, where yards against the team on defense includes completed offensive passing yards and completed offensive rushing yards;
determining realistic scoring values for fantasy football, based at least in part on each of the received data representative of a positive per-event portion, the received data representative of a negative pet-even portion, the received data representative of a positive per-yard portion, and the received data representative of a negative per-yard portion, where different positions account for different proportions of a team's performance.

12. The method of realistic scoring for fantasy football of claim 12, where scoring weightings are adjusted based on a statistical evaluation.

13. The method of realistic scoring for fantasy football of claim 11, further comprising receiving data representative of analysis from real professional football games using the positive and negative per-event and per-yard portions of the fantasy football scoring algorithm, analyzing the top performers as quarterbacks, running backs, wide receivers, tight ends, kickers, defense, and special teams, where the analysis informs adjusted values of per-event and per-yard scoring such that fantasy football team scores are normalized to real professional football team scores.

14. The method of realistic scoring for fantasy football of claim 11, wherein the scoring system is normalized to an average score based on a series of professional football games.

15. A non-transitory computer-readable medium storing instructions that, when executed by a processor, cause the processor to:
receive data representative of a positive per-event portion of a fantasy football scoring algorithm, that assigns positive points based on a multiplier for each of touchdown pass completed, touchdown rush completed, touchdown reception completed, turnovers for the team on defense from an interception, turnovers for the team on defense from a fumble recovery, 2-point conversions from passing, 2-point conversions from rushing, 2-point conversion receptions, successful extra points attempts, successful field goal attempts, interceptions by the defensive team, fumbles attributed to the team on defense, defensive sacks of a quarterback, safeties attributed to the team on defense, kickoff touchbacks, turnovers based on a fumble attributed to special teams, special teams touchdowns, special teams 1-point safety, and punts blocked by the defense;
receive data representative of a negative per-event portion of a fantasy football scoring algorithm, that assigns negative points based on a multiplier for each of turnovers from an interception charged against a team or player on offense, turnovers from a fumble recovery charged against a team or player on offense, unsuccessful kicking extra points attempts, and missed field goal attempts;
receive data representative of a positive per-yard portion of a fantasy football scoring algorithm, that assigns additional positive points based on a per-yard-multiplier for each of pass completed, rush completed, reception completed, touchdown pass completed, touchdown rush completed, touchdown reception completed, successful field goal attempts, touchdown yards by team on defense, touchdown yards by special teams, punt returns, kick off returns, and special teams touchdowns;
receive data representative of a negative per-yard portion of a fantasy football scoring algorithm, that assigns negative points based on a per-yard-multiplier for yards against the team on defense, where yards against the team on defense includes completed offensive passing yards and completed offensive rushing yards; and
determine realistic scoring values for fantasy football, based at least in part on each of the received data representative of a positive per-event portion, the received data representative of a negative pet-even portion, the received data representative of a positive per-yard portion, and the received data representative of a negative per-yard portion, where different positions account for different proportions of a team's performance.

16. The non-transitory computer-readable medium of claim 15, where scoring weightings are adjusted based on statistical evaluation.

17. The non-transitory computer-readable medium of claim 15, where the instructions, when executed by a processor, further cause the processer to receive data representative of analysis from real professional football games using the positive and negative per-event and per-yard portions of the fantasy football scoring algorithm, analyzing the top performers as quarterbacks, running backs, wide receivers, tight ends, kickers, defense, and special teams, where the analysis informs adjusted values of per-event and per-yard scoring such that fantasy football team scores are normalized to real professional football team scores.

18. The non-transitory computer-readable medium of claim 15, wherein the scoring system is normalized to an average score based on a series of professional football games.

19. The non-transitory computer-readable medium of claim 15, wherein the scores are normalized to approximately 28 points per game per team.

20. The non-transitory computer-readable medium of claim 15, wherein the positions include one quarterback, two running backs, two wide receivers, one tight end, one kicker, one defensive player, and one special team player.
